(19) United States
(12) Patent Application Publication
(10) Pub. No.: US 2018/0172167 A1
(43) Pub. Date: Jun. 21, 2018

(54) Connector Structure of Air Connector Adapted to Connect Presta (French) Valve and Schrader (American) Valve

(71) Applicant: BIRZMAN CORP., Dacun Township (TW)

(72) Inventors: Chung-Tsun Kuo, Dacun Township (TW); Chia-Hsun Huang, Dacun Township (TW); Wen-Pin Su, Dacun Township (TW)

(21) Appl. No.: 15/382,951

(22) Filed: Dec. 19, 2016

(51) Int. Cl. F16K 15/20; B60C 29/06

(52) U.S. Cl. CPC F16K 15/20; B60C 29/064

(57) ABSTRACT

A connector structure of an air connector contains: a body, two Schrader (American) retainers, two Presta (French) retainers, two fixing blocks, a control set, and a movable post. The body includes a Schrader (American) inserting hole, a Presta (French) inserting hole, an accommodation groove, an air intake, two first through orifices, two second through orifices, two receiving orifices, and an airtight washer. The two Schrader (American) retainers move in the two first through orifices. The two Presta (French) retainers move in the two second through orifices. The two fixing blocks move in the two receiving orifices. The control set is disposed on the body and controls a first limiting segment of each Schrader (American) retainer, a second limiting segment of each Presta (French) retainer, and a third limiting segment of each fixing block. The movable post is limited by the Presta (French) inserting hole and the accommodation groove.

### BACKGROUND OF THE INVENTION

### Field of the Invention

The present invention relates to an air connector for inflating air, and more particularly to an air connector structure of the air connector which is adapted to connect the Presta (French) valve and the Schrader (American) valve.

### Description of the Prior Art

Conventional valves for tires contain a Presta (French) valve and a Schrader (American) valve, and the Presta (French) valve and the Schrader (American) valve have two air connectors, respectively. User has to purchase the two air connectors to cause using inconvenience and high using cost.

The inventor of the present invention invented an air connector structure of the air connector which is adapted to connect the Presta (French) valve and the Schrader (American) valve and is disclosed in TW Patent Publication 1498479. The air connector is not replaced and is not operated complicatedly, but when it mates with the Schrader (American) valve to inflate air, inner threads of a Schrader (American) inserting hole of the air connector screw with outer threads of the Schrader (American) valve so that an opening of the Schrader (American) valve is pushed to open, thus inflating the air inconveniently and wasting using time. Furthermore, connection manners of the Schrader (American) valve and the Presta (French) valve are different to cause using confusion.

To improve above-mentioned problems, a quick air connector structure of an air connector is disclosed in TW Patent Publication 1544147 and contains a Presta (French) retainer configured to retain the Presta (French) valve, and the quick air connector structure contains a Schrader (American) retainer configured to retain the Schrader (American) valve so as to eliminate screwing time of the air connector and the Schrader (American) valve and to operate the air connector easily. However, when the air connector mates with the Schrader (American) valve, an operation ring is rotated so as to press a fixing element, the fixing element moves into an accommodation groove of a pushing needle to fix the pushing needle, and the Schrader (American) valve inserts into the air connector, thus having using inconvenience and long using time. The operation ring is rotated before the air connector is in connection with the Schrader (American) valve, so connecting operations of the Schrader (American) valve and the Presta (French) valve are different to cause using confusion.

The present invention has arisen to mitigate and/or obviate the afore-described disadvantages.

### SUMMARY OF THE INVENTION

The primary objective of the present invention is to provide a connector structure of an air connector which is adapted to connect the Presta (French) valve and the Schrader (American) valve simultaneously so as to inflate air, and the control set slides as operating the air connector to press each Schrader (American) retainer, each Presta (French) retainer, and the two fixing blocks, hence the air connector is connected with the Presta (French) valve or the Schrader (American) valve easily and clearly.

Accordingly, a connector structure of an air connector provided by the present invention contains: a body, two Schrader (American) retainers, two Presta (French) retainers, two fixing blocks, a control set, and a movable post.

The body includes a Schrader (American) inserting hole formed on a first end of the body, and the body includes a Presta (French) inserting hole, an outer diameter of which is less than an outer diameter of the Schrader (American) inserting hole. The Presta (French) inserting hole is spaced a distance away from an inner end of the Schrader (American) inserting hole, the body also includes an accommodation groove defined inside the Presta (French) inserting hole; an air intake defined on a second end of the body; two first through orifices arranged on an outer peripheral side of the Schrader (American) inserting hole and passing through the Schrader (American) inserting hole; two second through orifices arranged on an outer peripheral side of the Presta (French) inserting hole and passing through the Presta (French) inserting hole; two receiving orifice communicating with the Presta (French) inserting hole; and an airtight washer fixed between the Schrader (American) inserting hole and the Presta (French) inserting hole.

The two Schrader (American) retainers are accommodated and move in the two first through orifices individually so as to enter into or go away from the Schrader (American) inserting hole, and each of the two Schrader (American) retainers includes a first locking segment formed on a first end of each Schrader (American) retainer corresponding to the Schrader (American) inserting hole, the first locking segment has multiple first locking teeth, and each Schrader (American) retainer includes a first limiting segment arranged on a second end of each Schrader (American) retainer.

The two Presta (French) retainer are accommodated and move in the two second through orifices individually so as to enter into or go away from the Presta (French) inserting hole, and each of the two Presta (French) retainers includes a second locking segment formed on a first end of each Presta (French) retainer corresponding to the Presta (French) inserting hole, the second locking segment has multiple second locking teeth, and each Presta (French) retainer includes a second limiting segment arranged on a second end of each Presta (French) retainer.

The two fixing blocks are accommodated and move in the two receiving orifices individually so as to enter into or go away from the Presta (French) inserting hole, each of the two fixing blocks includes an abutting segment formed on a first end of each fixing block corresponding to the Presta (French) inserting hole, and each fixing block also includes a third locking segment formed on a second end of each fixing block.

The control set is disposed on the body and controls the first limiting segment of each Schrader (American) retainer, the second limiting segment of each Presta (French) retainer, and the third limiting segment of each fixing block.

The movable post is mounted in and limited by the Presta (French) inserting hole and the accommodation groove of the body, and the movable post includes a positioning slot and a biasing segment corresponding to the Schrader (American) inserting hole, such that the movable post allows air flowing therethrough, the positioning slot of the movable post and the abutting segment of each fixing block have a pushing structure, and the moving post is pushed by each fixing block to move toward and fix in the Schrader (American) inserting hole.

### BRIEF DESCRIPTION OF THE DRAWINGS

FIG. 1 is a perspective view showing the exploded components of a connector structure of an air connector in accordance with a preferred embodiment of the present invention.

FIG. 2 is a perspective view showing the assembly of the connector structure of the air connector in accordance with the preferred embodiment of the present invention.

FIG. 3 is a cross sectional view taken along the line A-A of FIG. 2.

FIG. 4 is a cross sectional view taken along the line B-B of FIG. 2.

FIG. 5 is a cross sectional view showing the operation of the connector structure of the air connector and a Schrader (American) valve in accordance with the preferred embodiment of the present invention.

FIG. 6 is a cross sectional view showing another operation of the connector structure of the air connector and the Schrader (American) in accordance with the preferred embodiment of the present invention.

FIG. 7 is an amplified cross sectional view of a part of FIG. 6.

FIG. 8 is a cross sectional view showing the operation of the connector structure of the air connector and the Schrader (American) valve in accordance with the preferred embodiment of the present invention.

FIG. 9 is a cross sectional view showing another operation of the connector structure of the air connector and the Schrader (American) valve in accordance with the preferred embodiment of the present invention.

FIG. 10 is an amplified cross sectional view of a part of FIG. 9.

FIG. 11 is a cross sectional view showing the operation of the connector structure of the air connector and a Presta (French) valve in accordance with the preferred embodiment of the present invention.

FIG. 12 is a cross sectional view showing the assembly of the connector structure of the air connector and the Presta (French) valve in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

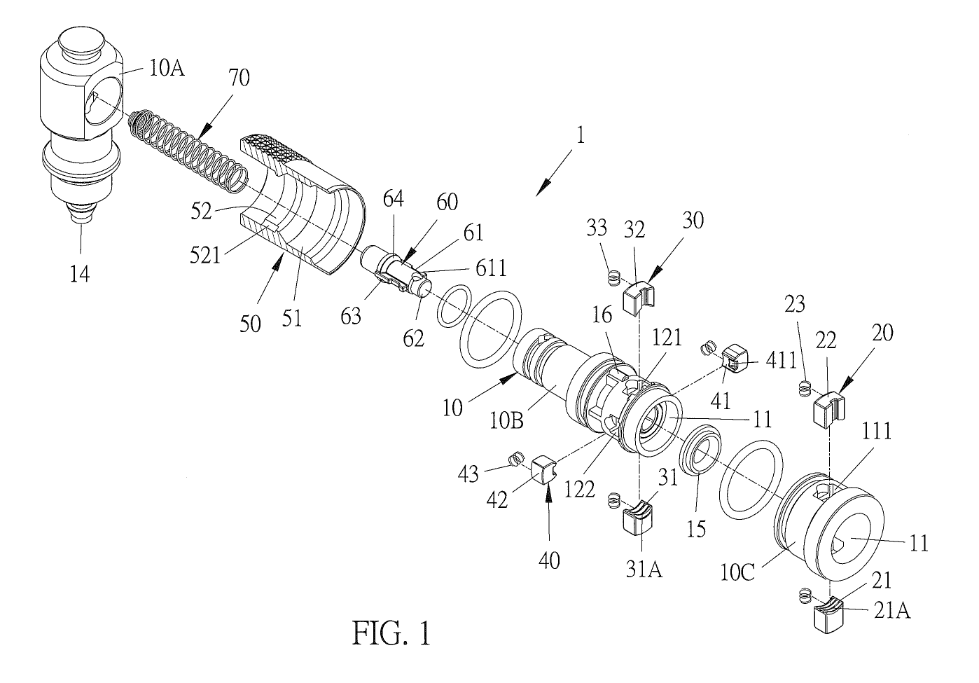

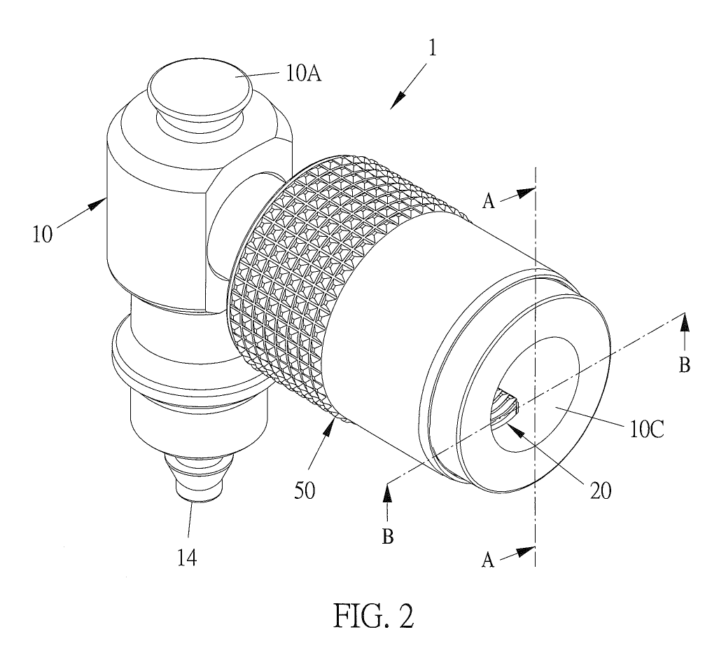

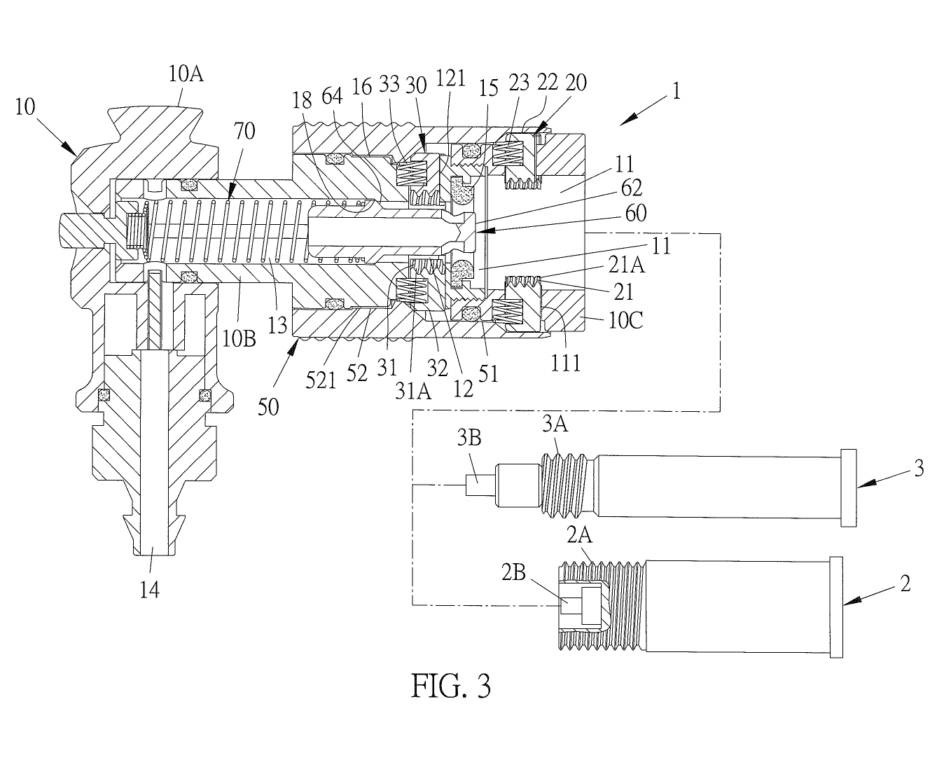

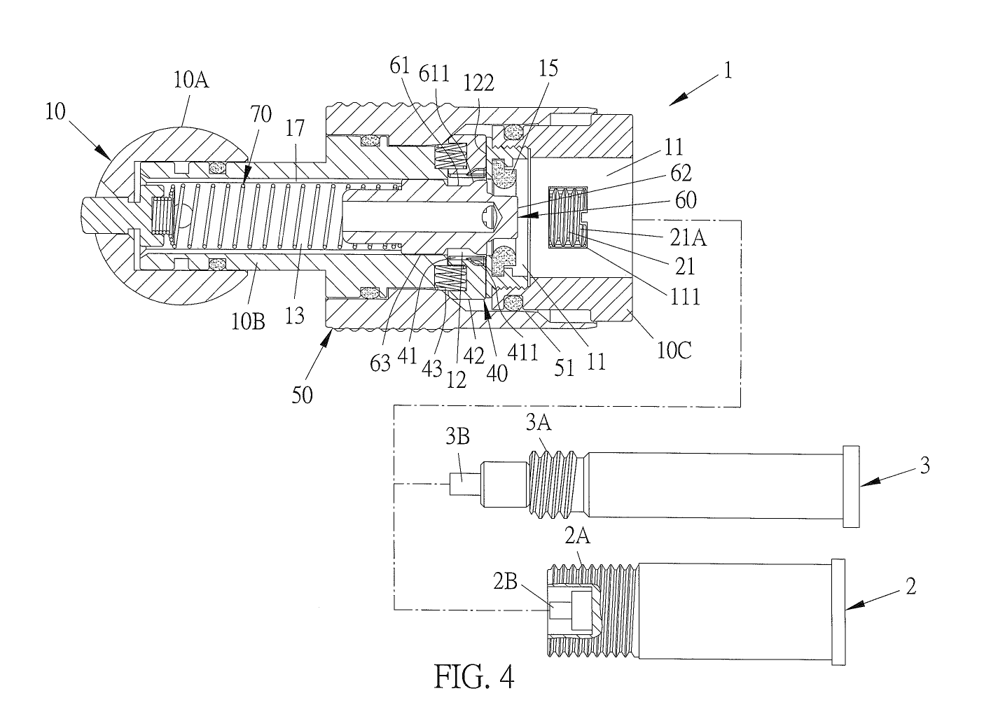

With reference to FIGS. 1 to 4, a connector structure of an air connector 1 according to a preferred embodiment of the present invention is connected with a Schrader (American) valve 2 or a Presta (French) valve 3 so as to inflate air, wherein the Schrader (American) valve 2 includes Schrader (American) threads 2A arranged around an outer peripheral side thereof and includes a Schrader (American) inlet part 2B disposed in an end portion thereof, and the Presta (French) valve 3 includes Presta (French) threads 3A arranged around an outer peripheral side thereof and includes a Presta (French) inlet part 3B mounted in an end portion thereof. The air connector 1 comprises: a body 10, two Schrader (American) retainers 20, two Presta (French) retainers 30, two fixing blocks 40, a control set 50, a movable post 60, and a forcing spring 70.

The body 10 includes a Schrader (American) inserting hole 11 formed on a first end thereof and includes a Presta (French) inserting hole 12, an outer diameter of which is less than an outer diameter of the Schrader (American) inserting hole 11, and the Presta (French) inserting hole 12 is spaced a distance away from an inner end of the Schrader (American) inserting hole 11; an accommodation groove 13 defined inside the Presta (French) inserting hole 12; an air intake 14 defined on a second end of the body 10 and communicating with the Schrader (American) inserting hole 11, the Presta (French) inserting hole 12, and the accommodation groove 13; two first through orifices 111 arranged on an outer peripheral side of the Schrader (American) inserting hole 11 and passing through the Schrader (American) inserting hole 11; two second through orifices 121 arranged on an outer peripheral side of the Presta (French) inserting hole 12 and passing through the Presta (French) inserting hole 12; two receiving orifices 122 communicating with the Presta (French) inserting hole 12. The two first through orifices 111 are identical to each other and are arranged on two opposite peripheral sides of the body 10 respectively, the two second through orifices 121 are identical to each other and are arranged on the two opposite peripheral sides of the body 10, and the two receiving orifices 122 are identical to each other and are arranged on the two opposite peripheral sides of the body 10, wherein the two receiving orifices 122 are separated from each other, and an airtight washer 15 is fixed between the Schrader (American) inserting hole 11 and the Presta (French) inserting hole 12.

The two Schrader (American) retainers 20 are accommodated and move in the two first through orifices 111 individually so as to enter into or go away from the Schrader (American) inserting hole 11, and each of the two Schrader (American) retainers 20 includes a first locking segment 21 formed on a first end thereof corresponding to the Schrader (American) inserting hole 11, the first locking segment 21 has multiple first locking teeth 21A so that the first locking segment 21 and the multiple first locking teeth 21A match with the Schrader (American) threads 2A of the Schrader (American) valve 2. Each Schrader (American) retainer 20 includes a first limiting segment 22 arranged on a second end thereof, and between each Schrader (American) retainer 20 and the body 10 is defined a first push spring 23 configured to push each Schrader (American) retainer 20 away from the Schrader (American) inserting hole 11.

The Presta (French) retainers 30 are accommodated and move in the two second through orifices 121 individually so as to enter into or go away from the Presta (French) inserting hole 12, and each of the two Presta (French) retainers 30 includes a second locking segment 31 formed on a first end of each Presta (French) retainer 30 corresponding to the Presta (French) inserting hole 12, the second locking segment 31 has multiple second locking teeth 31A so that the second locking segment 31 and the multiple second locking teeth 31A match with the Presta (French) threads 3A of the Presta (French) valve 3. Each Presta (French) retainer 30 includes a second limiting segment 32 arranged on a second end thereof, and between each Presta (French) retainer 30 and the body 10 is defined a second push spring 33 configured to push each Presta (French) retainer 30 away from the Presta (French) inserting hole 12.

The two fixing blocks 40 are accommodated and move in the two receiving orifices 122 individually so as to enter into or go away from the Presta (French) inserting hole 12, and each of the two fixing blocks 40 includes an abutting segment 41 formed on a first end of each fixing block 40 corresponding to the Presta (French) inserting hole 12. Each fixing block 40 also includes a third locking segment 42 formed on a second end thereof, and between each fixing block 40 and the body 10 is defined a third push spring 43 configured to push each fixing block 40 away from the Presta (French) inserting hole 12.

The control set 50 is disposed on the body 10 and controls the first limiting segment 22 of each Schrader (American) retainer 20, the second limiting segment 32 of each Presta (French) retainer 30, and the third limiting segment 42 of each fixing block 40, such that the first locking segment 21 and the multiple first locking teeth 21A of each Schrader (American) retainer 20 move in or away from the Schrader (American) inserting hole 11, the second locking segment 31 and the multiple second locking teeth 31A of each Presta (French) retainer 30 move in or away from the Presta (French) inserting hole 12, and the abutting segment 41 of each fixing block 40 moves in or away from the Presta (French) inserting hole 12. The control set 50 is a rotatable ring and is fitted with the body 10. The control set 50 includes a first press protrusion 51, a second press protrusion 52, and two trenches 521 defined on the second press protrusions 52. The control set 50 also includes two slide rails 16 formed on two connection areas of the two trenches 521 and the body 10 so that the two trenches 521 slide along the two slide rails 16. When the two trenches 521 slide away from the two slide rails 16, the control set 50 is rotated so as to drive the second press protrusion 52 to stop the two slide rails 16. The control set 50 controls the first press protrusion 51 to stop the first limiting segment 22 of each Schrader (American) retainer 20, after the first limiting segment 22 moves. The control set 50 controls the second press protrusion 52 to stop the second limiting segment 32 of each Presta (French) retainer 30, after the second limiting segment 22 moves. Furthermore, the control set 50 controls the second press protrusion 52 to stop the third limiting segment 42 of each fixing block 40, after the third limiting segment 42 moves.

The movable post 60 is mounted in and is limited by the Presta (French) inserting hole 12 and the accommodation groove 13 of the body 10, and the movable post 60 includes a positioning slot 61 and a biasing segment 62 corresponding to the Schrader (American) inserting hole 11, such that the movable post 60 allows the air flowing therethrough. The biasing segment 62 corresponds to the Schrader (American) inlet part 2B, and the positioning slot 61 of the movable post 60 and two abutting segments 41 of the two fixing blocks 40 have a pushing structure. In this embodiment, the pushing structure is two tilted faces 611, 411. When the two abutting segments 41 of the two fixing blocks 40 move into the Presta (French) inserting hole 12, the pushing structure drives the movable post 60 to move toward the Schrader (American) inserting hole 11 by using component of force, and when the two abutting segments 41 of the two fixing blocks 40 move into the positioning slot 61 of the movable post 60, the movable post 60 is positioned. The movable post 60 further includes a slidable rib 63 arranged on a peripheral side thereof, the Presta (French) inserting hole 12 and the accommodation groove 13 of the body 10 have a trough 17 matching with the slidable rib 63, hence when the movable post 60 is controlled to move, the slidable rib 63 slides in the trough 17 so as to stop the movable post 60.

The forcing spring 70 is defined between the accommodation groove 13 of the body 10 and the movable post 60.

The accommodation groove 13 of the body 10 has a first shoulder 18 proximate to the Presta (French) inserting hole 12, and the movable post 60 includes a second shoulder 64 formed thereon, such that when the movable post 60 moves in the accommodation groove 13 and the second shoulder 64 abuts against the first shoulder 18, the movable post 60 does not move toward the Schrader (American) inserting hole 11.

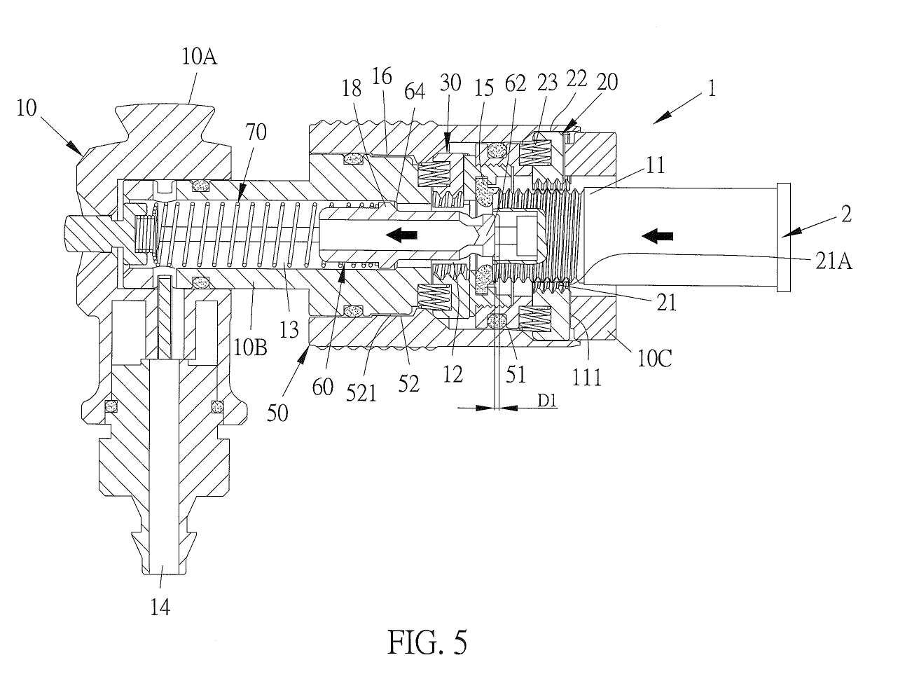

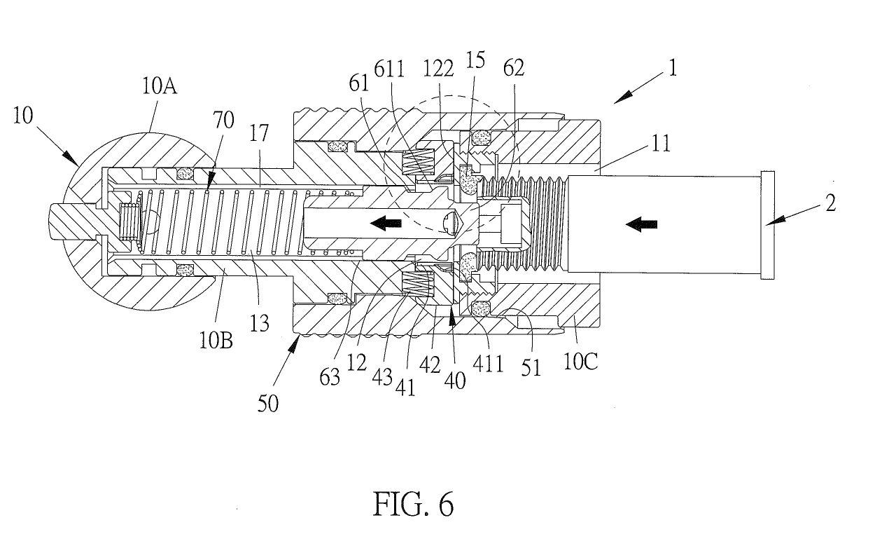

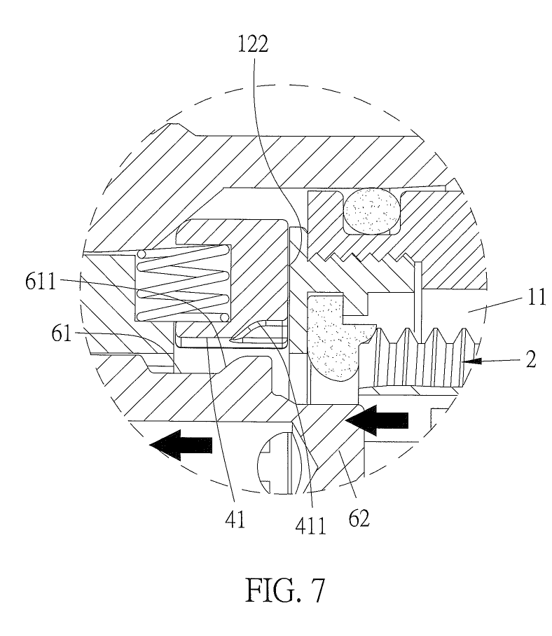

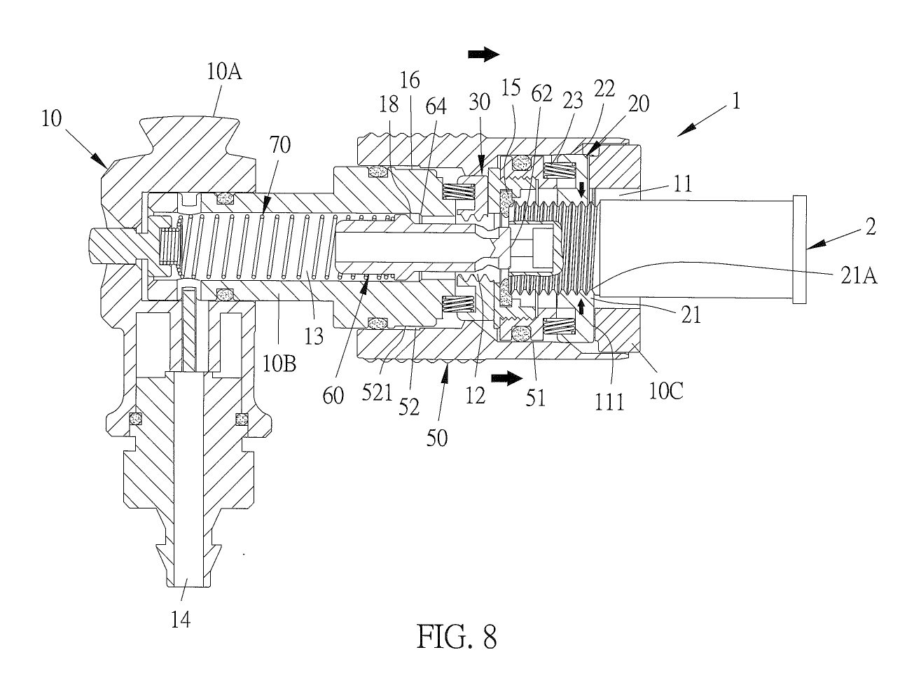

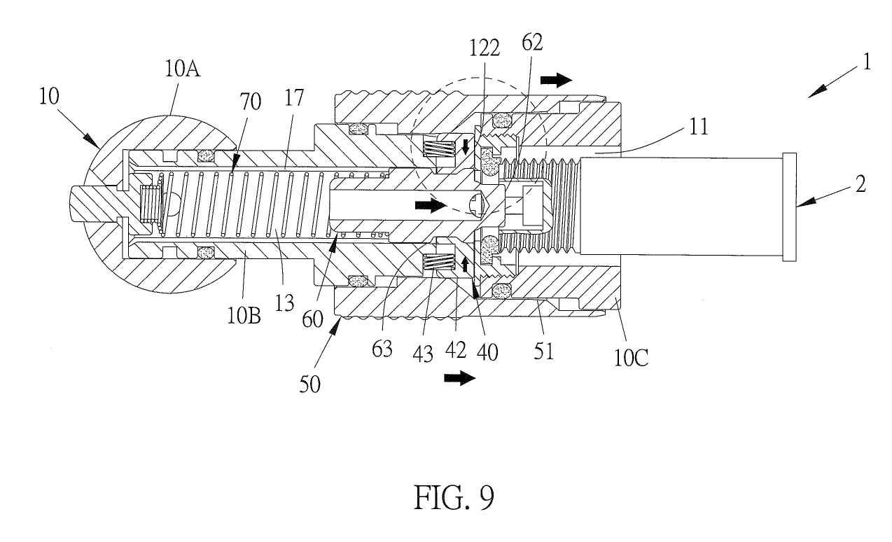

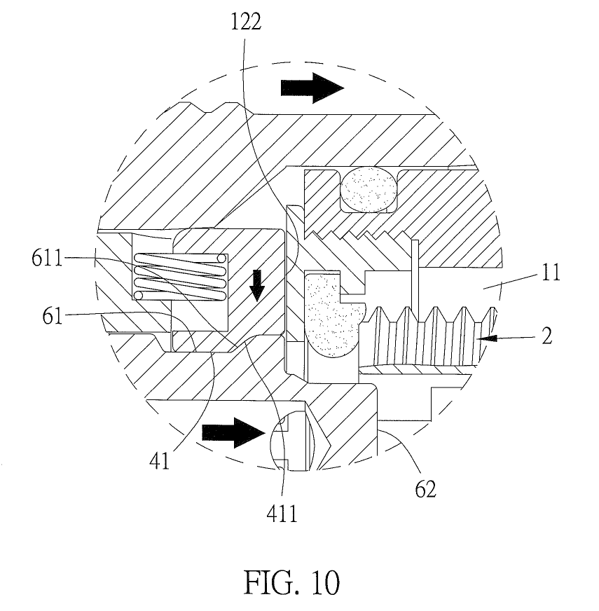

When the air connector 1 is in connection with the Schrader (American) valve 2 to inflate the air, as shown in FIGS. 5 to 7, the Schrader (American) valve 2 is coupled to the Schrader (American) inserting hole 11 of the body 10 and presses the airtight washer 15 which is fixed between the Schrader (American) inserting hole 11 and the Presta (French) inserting hole 12 so that the Schrader (American) threads 2A align with the multiple first locking teeth 21A of each Schrader (American) retainer 20, and the Schrader (American) valve 2 and the Schrader (American) inserting hole 11 are airproofed by the airtight washer 15, wherein the movable post 60 is pushed a distance D1 toward the accommodation groove 13 so as to press the forcing spring 70, hence the positioning slot 61 of the movable post 60 aligns with the two abutting segments 41 of the two fixing blocks 40. Referring to FIGS. 8 to 10, when the control set 50 slides on the body 1 so that the first limiting segment 22 of each Schrader (American) retainer 20 is pressed and limited by the first press protrusion 51 of the control set 50, each Schrader (American) retainer 20 is controlled to move into the Schrader (American) inserting hole 11, and the multiple first locking teeth 21A of each Schrader (American) retainer 20 engage with the Schrader (American) threads 2A of the Schrader (American) valve 2, thus fixing the Schrader (American) valve 2. In the meantime, the second press protrusion 52 of the control set 50 is biased against and limits the two fixing blocks 40 so that the two fixing blocks 40 move toward and are fixed in the Presta (French) inserting hole 12. The component of force pushes the movable post 60 toward the Schrader (American) inserting hole 11 by using the two tilted faces 611, 411 of the pushing structure so that the Schrader (American) inlet part 2B of the Schrader (American) valve 2 is pressed by the movable post 60 to open, and when the two abutting segments 41 of the two fixing blocks 40 move into the positioning slot 61 of the movable post 60, they fix the movable post 60, hence the air is inflated into the Schrader (American) valve 2 via the air connector 1.

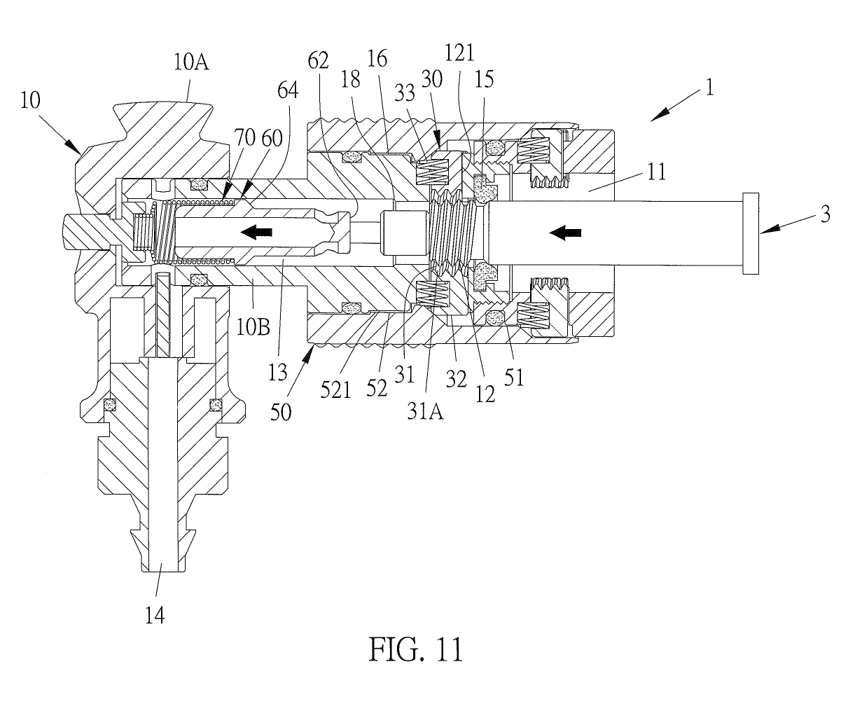

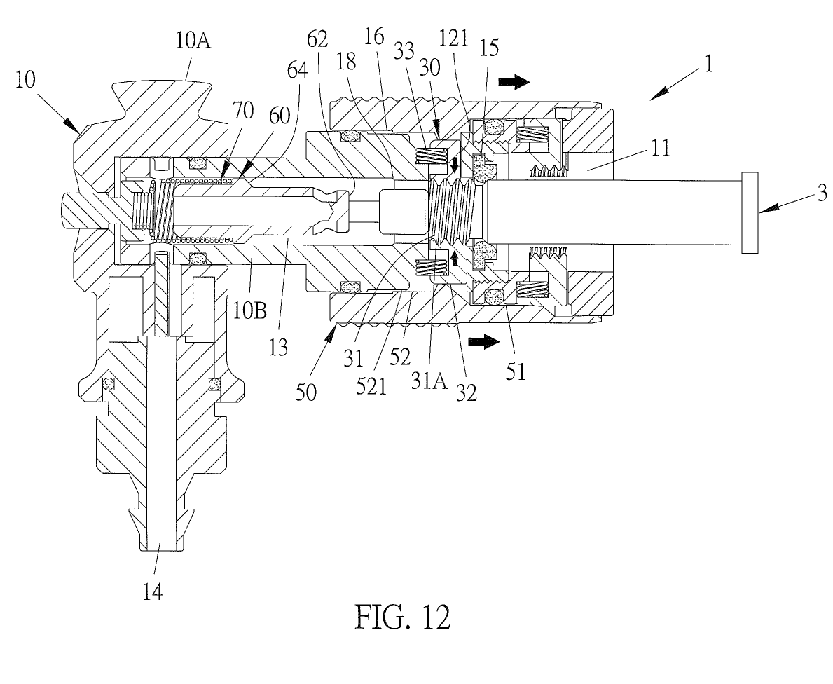

As the air connector 1 is connected with the Presta (French) valve 3, as illustrated in FIG. 11, the Presta (French) valve 3 is coupled to the Presta (French) inserting hole 12 of the body 10 so as to push the movable post 60 toward the accommodation groove 13, hence the movable post 60 presses the forcing spring 70 so that the movable post 60 removes from the Presta (French) inserting hole 12, the Presta (French) threads 3A align with the multiple second locking teeth 31A of each Presta (French) retainer 30, and the outer peripheral side of the Presta (French) valve 3 engages with the airtight washer 15 to as to form an airtight state. Referring further to FIG. 12, the control set 50 is slid on the body 10 so that the second limiting segment 32 of each Presta (French) retainer 30 is pressed and limited by the second press protrusion 52 of the control set 50, and each Presta (French) retainer 30 is controlled to move and fix in the Presta (French) inserting hole 12, hence the multiple second locking teeth 31A of each Presta (French) retainer 30 engage with the Presta (French) threads 3A of the Presta (French) valve 3, thus positioning the Presta (French) valve 3. Thereafter, the Presta (French) inlet part 3B is opened by a pressure as inflating the air so that the air is inflated into the Schrader (American) valve 2 via the air connector 1.

When the spring 70 is not used, the movable post 60 is urged by a force to move toward the Schrader (American) inserting hole 11, wherein the force is pneumatic force.

The body 10 is comprised of a first part 10A, a second part 10B, and a third part 10C, wherein the first part 10A is in connection with the second part 10B, the second part 10B is coupled with the third part 10C, and connection of the first part 10A and the second part 10B is obtained in a right-angle turning manner. The air intake 14 is defined on the first part 10A. The accommodation groove 13, the Presta (French) inserting hole 12, the two second through orifices 121, and the two receiving orifices 122 are arranged on the second part 10B, the Schrader (American) inserting hole 11 is defined between the second part 10B and the third part 10C, and the two first through orifices 111 are formed on the third part 10C.

After the air connector 1 is connected with the Schrader (American) valve 2, it is manually rotated based on Schrader (American) valve 2 of various sizes so that the Schrader (American) threads 2A of the Schrader (American) valve 2 mate with the multiple first locking teeth 21A of each Schrader (American) retainer 20 to move toward the accommodation groove 13, hence the air connector 1 is connected with the Schrader (American) valve 2 in an optimal connection position.

The connector structure of the air connector of the present invention has advantages as follows:

the connector structure of the air connector 1 is adapted to valves of two sizes, for example, one end of the air connector 1 is adapted to connect the Presta (French) valve 2 and the Schrader (American) valve simultaneously so as to inflate the air, and the control set 50 slides as operating the air connector 1 to press each Schrader (American) retainer 20, each Presta (French) retainer 30, and the two fixing blocks 40. Accordingly, the air connector 1 is connected with the Presta (French) valve 2 or the Schrader (American) valve easily and clearly.

While we have shown and described various embodiments in accordance with the present invention, it is clear to those skilled in the art that further embodiments may be made without departing from the scope of the present invention.

What is claimed is:

1. A connector structure of an air connector being adapted to connect a Presta (French) valve and a Schrader (American) valve, and the connector structure comprising:
a body including a Schrader (American) inserting hole formed on a first end of the body, and the body including a Presta (French) inserting hole, an outer diameter of which is less than an outer diameter of the Schrader (American) inserting hole, and the Presta (French) inserting hole being spaced a distance away from an inner end of the Schrader (American) inserting hole, the body also including an accommodation groove defined inside the Presta (French) inserting hole; an air intake defined on a second end of the body; at least one first through orifice arranged on an outer peripheral side of the Schrader (American) inserting hole and passing through the Schrader (American) inserting hole; at least one second through orifice arranged on an outer peripheral side of the Presta (French) inserting hole and passing through the Presta (French) inserting hole; at least one receiving orifice communicating with the Presta (French) inserting hole; and an airtight washer fixed between the Schrader (American) inserting hole and the Presta (French) inserting hole;
at least one Schrader (American) retainer accommodated and moving in the at least one first through orifice individually so as to enter into or go away from the Schrader (American) inserting hole, and each of the at least one Schrader (American) retainer including a first locking segment formed on a first end of each Schrader (American) retainer corresponding to the Schrader (American) inserting hole, the first locking segment having multiple first locking teeth, and each Schrader (American) retainer including a first limiting segment arranged on a second end of each Schrader (American) retainer;
at least one Presta (French) retainer accommodated and moving in the at least one second through orifice individually so as to enter into or go away from the Presta (French) inserting hole, and each of the at least one Presta (French) retainer including a second locking segment formed on a first end of each Presta (French) retainer corresponding to the Presta (French) inserting hole, the second locking segment having multiple second locking teeth, and each Presta (French) retainer including a second limiting segment arranged on a second end of each Presta (French) retainer;
at least one fixing block accommodated and moving in the at least one receiving orifice individually so as to enter into or go away from the Presta (French) inserting hole, each of the at least one fixing block including an abutting segment formed on a first end of each fixing block corresponding to the Presta (French) inserting hole, and each fixing block also including a third locking segment formed on a second end of each fixing block;
a control set disposed on the body and controlling the first limiting segment of each Schrader (American) retainer, the second limiting segment of each Presta (French) retainer, and the third limiting segment of each fixing block; and
a movable post mounted in and limited by the Presta (French) inserting hole and the accommodation groove of the body, and the movable post including a positioning slot and a biasing segment corresponding to the Schrader (American) inserting hole, such that the movable post allows air flowing therethrough, the positioning slot of the movable post and the abutting segment of each fixing block having a pushing structure, and the moving post being pushed by each fixing block to move toward and fix in the Schrader (American) inserting hole;
when the air connector mates with the Schrader (American) valve to inflate the air, the Schrader (American) valve is coupled to the Schrader (American) inserting hole of the body, and air in the Schrader (American) valve is stopped by the airtight washer, wherein Schrader (American) threads align with the multiple first locking teeth of each Schrader (American) retainer, and the movable post is pushed a distance by the Schrader (American) valve to move toward the accommodation groove, the positioning slot of the movable post aligns with the abutting segment of each fixing block, the control set is operated so that the multiple first locking teeth of each Schrader (American) retainer engage with the Schrader (American) threads of the Schrader (American) valve, the Schrader (American) valve is fixed, and each fixing block is pushed into the Presta (French) valve, the movable post is pushed into the Schrader (American) valve so that a Schrader (American) inlet part of the Schrader (American) valve is pushed by the biasing segment of the movable post to open, and when the abutting segment of each fixing block moves into the positioning slot of the movable post, the abutting segment fixes the movable post, hence the air is inflated into the Schrader (American) valve via the air connector;
when the air connector mates with the Presta (French) valve to inflate the air, the movable post removes form the Presta (French) inserting hole as the Presta (French) valve moves to the accommodation groove, Presta (French) threads align with the multiple second locking teeth of each Presta (French) retainer, air in the Presta (French) valve is stopped by the airtight washer, the control set is operated so that the multiple second locking teeth of each Presta (French) retainer engage with the Presta (French) threads of the Presta (French) valve, the Presta (French) valve is fixed so that the Presta (French) inlet part is opened by a pressure as inflating the air, and the air connector inflates the air to the Presta (French) valve.

2. The connector structure of the air connector as claimed in claim 1, wherein a forcing spring is defined between the accommodation groove of the body and the movable post, and the movable post is urged by a force to move toward the Schrader (American) inserting hole, wherein the force is pushing force of the forcing spring.

3. The connector structure of the air connector as claimed in claim 1, wherein the movable post is urged by a force to move toward the Schrader (American) inserting hole, wherein the force is pneumatic force.

4. The connector structure of the air connector as claimed in claim 1, wherein the pushing structure is two tilted faces, when two abutting segments of two fixing blocks move into the Presta (French) inserting hole, the pushing structure drives the movable post to move toward the Schrader (American) inserting hole by using component of force, and when the two abutting segments of the two fixing blocks move into the positioning slot of the movable post, the movable post is positioned.

5. The connector structure of the air connector as claimed in claim 1, wherein the accommodation groove of the body has a first shoulder proximate to the Presta (French) inserting hole, and the movable post includes a second shoulder formed thereon, such that when the movable post moves in the accommodation groove and the second shoulder abuts against the first shoulder, the movable post does not move toward the Schrader (American) inserting hole.

6. The connector structure of the air connector as claimed in claim 1, wherein the body is comprised of a first part, a second part, and a third part, wherein the first part is in connection with the second part, the second part is coupled with the third part, the air intake is defined on the first part, the accommodation groove, the Presta (French) inserting hole, the at least one second through orifice, and the at least one receiving orifice are arranged on the second part, the Schrader (American) inserting hole is defined between the second part and the third part, and the at least one first through orifice is formed on the third part.

7. The connector structure of the air connector as claimed in claim 1, wherein between each Schrader (American) retainer and the body is defined a first push spring configured to push each Schrader (American) retainer away from the Schrader (American) inserting hole.

8. The connector structure of the air connector as claimed in claim 1, wherein between each Presta (French) retainer and the body is defined a second push spring configured to push each Presta (French) retainer away from the Presta (French) inserting hole.

9. The connector structure of the air connector as claimed in claim 1, wherein between each fixing block and the body is defined a third push spring configured to push each fixing block away from the Presta (French) inserting hole.

10. The connector structure of the air connector as claimed in claim 1, wherein the control set is a rotatable ring and is fitted with the body, the control set includes a first press protrusion, a second press protrusion, and two trenches defined between the first and second press protrusions, the control set also includes two slide rails formed on two connection areas of the two trenches and the body so that the two trenches slide along the two slide rails; when the two trenches slide away from the two slide rails, the control set is rotated so as to drive the second press protrusion to stop the two slide rails; the control set controls the first press protrusion to stop the first limiting segment of each Schrader (American) retainer, after the first limiting segment moves; the control set controls the second press protrusion to stop the second limiting segment of each Presta (French) retainer, after the second limiting segment moves; and the control set controls the second press protrusion to stop the third limiting segment of each fixing block, after the third limiting segment moves.
